(19) United States
(12) Patent Application Publication
(10) Pub. No.: US 2026/0183711 A1
(43) Pub. Date: Jul. 2, 2026

(54) PHOTOCATALYTIC PURIFICATION DEVICE

(71) Applicant: Yunnan University, Kunming (CN)

(72) Inventors: Jiaqiang Wang, Kunming (CN); Yi Zhao, Kunming (CN); Junyang Leng, Kunming (CN)

(21) Appl. No.: 19/394,832

(22) Filed: Nov. 19, 2025

(30) Foreign Application Priority Data
Jan. 2, 2025 (CN) 202510003610.5

(51) Int. Cl. B01D 53/88; B01D 46/00; B01D 46/02; B01D 46/681; B01D 53/00; B01D 53/04; B03C 3/017; B03C 3/45; B03C 3/74; C02F 1/32; C02F 1/72

(52) U.S. Cl. CPC B01D 53/885; B01D 46/0032; B01D 46/0036; B01D 46/0041; B01D 46/0047; B01D 46/02; B01D 46/681; B01D 53/007; B01D 53/04; B03C 3/017; B03C 3/45; B03C 3/743; C02F 1/325; C02F 1/725; B01D 2253/102; B01D 2255/802; B01D 2259/804; C02F 2305/10

(57) ABSTRACT

The disclosure is applicable to the technical field of purification devices. Provided is a photocatalytic purification device, including a filtration box, a catalytic purification box, and a solution reaction tank which are fixed on a device frame. The solution reaction tank is mounted at a tank mounting position of the device frame and is used for purifying wastewater. The filtration box and the catalytic purification box are used in combination to purify waste gas. An air intake pipe is arranged on one side of the filtration box. The photocatalytic purification device provided in the solution not only offers catalytic purification of air but also meets the requirements for purifying wastewater and other solutions, fulfilling the need for multi-purpose applications. Moreover, the continuous and efficient filtration capacity of an air filtration net is guaranteed, and the stable purification effect is achieved.

### CROSS-REFERENCE TO RELATED APPLICATION

This application claims priority of Chinese Patent Application No. 202510003610.5, filed on Jan. 2, 2025, the entire contents of which are incorporated herein by reference.

### TECHNICAL FIELD

The disclosure relates to the technical field of purification devices, and in particular relates to a photocatalytic purification device.

### BACKGROUND

With the accelerating modernization of cities and the diversification of industrial models, the quality of people's living environment has been deteriorating. The waste gas discharged from chemical plants, steelworks, pharmaceutical factories, as well as coking plants and oil refineries, is highly odorous, severely polluting the environment and endangering human health.

In the prior art, a purification device such as that disclosed in the patent document with publication number CN 107983065 A employs a method of adsorbing and filtering dust first, then performing photocatalytic purification, and finally spraying for air purification. In the document, to prevent filtration net clogging, a motor-driven stirring rod is used for cleaning the filtration net.

However, when cleaning, the circular stirring rod has a relatively small distributed cleaning area, making it difficult to achieve better anti-clogging effects. Moreover, although the impurities on the surface of the filtration net are swept away, impurities inside filtration holes tend to accumulate and cannot be removed. With the increase of blockage and pressure, the impurities in the filtration holes can easily pass through the filtration net. In addition, the current purification devices typically can only purify either wastewater or waste gas, which have no good distributed structure, and are significantly limited in use.

### SUMMARY

The disclosure provides a photocatalytic purification device, aiming to solve the current problems proposed in the background that impurities in the filtration holes of the filtration net cannot be removed and only either wastewater or waste gas can be purified at the same time.

To solve the above-described problems, the disclosure is realized as follows. A photocatalytic purification device includes a filtration box, a catalytic purification box, and a solution reaction tank which are fixed on a device frame, where the solution reaction tank is mounted at a tank mounting position of the device frame and is used for purifying wastewater, the filtration box and the catalytic purification box are used in combination to purify waste gas, an air intake pipe is arranged on one side of the filtration box, an air intake connecting pipe and an air discharge connecting pipe are arranged at a top of the filtration box and a top of the catalytic purification box, respectively, the air intake connecting pipe and the air discharge connecting pipe are connected to a same induced draft fan used for drawing filtered air from the filtration box and discharging same into the catalytic purification box for catalytic purification, an air discharge pipe is arranged on one side of the catalytic purification box, and the air discharge pipe is connected to the solution reaction tank to introduce purified air; and the filtration box is internally divided into a filtration chamber and an impurity collection chamber, where the filtration chamber is in communication with the air intake pipe and the air intake connecting pipe, the impurity collection chamber is located at a bottom of the filtration box and below the filtration chamber, and the filtration chamber and the impurity collection chamber are not in communication; a rectangular frame, where the rectangular frame is fixedly mounted inside the filtration chamber, an air filtration net is fixedly mounted inside the rectangular frame, a plurality of filtration holes are evenly distributed on the air filtration net, and the plurality of filtration holes are arranged in a plurality of rows; and an adsorption filtration net dredging mechanism, where the adsorption filtration net dredging mechanism is arranged inside the filtration chamber, and is used for clearing the filtration holes of the air filtration net.

Preferably, the adsorption filtration net dredging mechanism includes a high-pressure air jet pipe and an impurity collection pipe; the high-pressure air jet pipe and the impurity collection pipe are slidably arranged at an upper part of the rectangular frame and at a lower part of the air filtration net, respectively, and the high-pressure air jet pipe and the impurity collection pipe are capable of sliding horizontally along a direction in which the filtration holes of the air filtration net are arranged; a plurality of air jet hoods are arranged at a bottom of the high-pressure air jet pipe, and a plurality of impurity collection hoods are arranged at a top of the impurity collection pipe; the number of the air jet hoods and the impurity collection hoods is the same as the number of rows of the filtration holes, with corresponding positions; corresponding air jet hoods and impurity collection hoods are located on a same vertical line, enabling to simultaneously block same filtration holes; and a diameter of an opening of the air jet hood is larger than a diameter of the filtration hole, and a diameter of an opening of the impurity collection hood is larger than the diameter of the opening of the air jet hood.

Preferably, the adsorption filtration net dredging mechanism further includes a connecting pipe I, an impurity discharge hose, an impurity collection filter bag, a high-pressure air introduction mechanism, and a horizontal driving power mechanism; the connecting pipe I is connected to the impurity collection pipe, and the impurity discharge hose is connected to the connecting pipe I, with an impurity discharge end extending into the impurity collection chamber; the impurity collection filter bag is arranged inside the impurity collection chamber, and an opening of the impurity collection filter bag is sleeved on the impurity discharge end of the impurity discharge hose; and a filter bag access door is detachably mounted on one side of the bottom of the filtration box, and an air exhaust hole is disposed on the filter bag access door.

Preferably, the high-pressure air introduction mechanism includes a connecting pipe II, an air intake hose, an external connecting pipe, a control valve I, and a control valve II; the connecting pipe II is connected to the high-pressure air jet pipe, and the air intake hose is connected to the connecting pipe II; the external connecting pipe penetrates through a wall of the filtration box, with an air intake end connected to the air discharge connecting pipe, and an air exhaust end connected to an air intake end of the air intake hose; and the control valve I is arranged on the air discharge connecting pipe, an air intake end of the external connecting pipe is arranged between the induced draft fan and the control valve I, and the control valve II is arranged on the external connecting pipe;

Preferably, the horizontal driving power mechanism includes a fixing plate I, a fixing plate II, two guide strip plates, two horizontal movement screws, two synchronous wheels I, a synchronous belt I, a motor base, and a driving motor; the fixing plate I and the fixing plate II are fixedly mounted on the connecting pipe II and the connecting pipe I, respectively; the two guide strip plates slide through the fixing plate I and the fixing plate II, respectively, with two ends of each of the two guide strip plates fixedly connected to inner walls of two sides of the filtration chamber; the two horizontal movement screws are threaded through the fixing plate I and the fixing plate II in a driving manner, respectively, with two ends of each of the two horizontal movement screws rotatably connected to the inner walls on the two sides of the filtration chamber, two ends of each of the two horizontal movement screws extend outside the filtration box, and the guide strip plates and the horizontal movement screws are arranged in a same direction; the two synchronous wheels I are fixedly mounted at same ends of the two horizontal movement screws, respectively, and the synchronous belt I is looped around the two synchronous wheels I; and the motor base is fixedly mounted on one side of the filtration box, the driving motor is fixedly mounted on the motor base, and an output shaft of the driving motor is fixedly connected to an end of a corresponding horizontal movement screw.

Preferably, the high-pressure air jet pipe, the impurity collection pipe, the connecting pipe I, and the connecting pipe II are all rigid pipes, and a frame edge width of the rectangular frame is greater than a width of the high-pressure air jet pipe, the impurity collection pipe, the connecting pipe I, the connecting pipe II, the fixing plate I, and the fixing plate II.

Preferably, a diameter of the external connecting pipe is larger than that of the air intake hose, the air intake end of the external connecting pipe is inclined in a windward direction, and the windward direction refers to a direction from an air outlet end of the induced draft fan to an air exhaust end of the air discharge connecting pipe.

Preferably, rectangular sliding openings and threaded holes are disposed on the fixing plate I and the fixing plate II, the guide strip plates slide through corresponding rectangular sliding openings, and the horizontal movement screws penetrate through corresponding threaded holes in a threaded engagement manner.

Preferably, an activated carbon layer is detachably mounted inside the filtration chamber, and the activated carbon layer is positioned above the air filtration net and the adsorption filtration net dredging mechanism.

Preferably, the catalytic purification box is internally divided into a photocatalytic purification chamber at an upper part and a spraying chamber at a lower part, the photocatalytic purification chamber is in communication with the air discharge connecting pipe, and the spraying chamber is in communication with the air discharge pipe; a plurality of rows of photocatalytic lamp tubes and catalytic reaction layers are mounted inside the photocatalytic purification chamber in a staggered manner, to catalyze and purify air; and the photocatalytic purification chamber and the spraying chamber are in communication via a guiding elbow pipe.

The photocatalytic purification device is applied to the treatment of wastewater and waste gas.

Compared with the related art, the photocatalytic purification device provided by the disclosure has the following beneficial effects.

Compared with the prior art, according to the photocatalytic purification device provided in the solution, an adsorption filtration net dredging mechanism is used to unclog the filtration holes of the air filtration net, preventing blockages. By introducing high-pressure air from above and collecting impurities from below, the clearance of the filtration holes is achieved. This method is distinguished from traditional methods that merely clean the surface. Impurities are uniformly collected into the impurity collection chamber, achieving better cleaning performance. This step ensures the sustained and efficient filtration capability of the air filtration net, and guarantees stable purification effects. Additionally, the overall solution not only enables catalytic purification of air but also meets the requirements for purifying wastewater and other solutions, fulfilling multi-purpose needs.

### BRIEF DESCRIPTION OF THE DRAWINGS

FIG. 1 is a front-view three-dimensional structural schematic diagram of a photocatalytic purification device according to the disclosure;

FIG. 2 is a three-dimensional structural schematic diagram of an opposite side of the photocatalytic purification device as shown in FIG. 1;

FIG. 3 is a rear-view structural schematic diagram of the photocatalytic purification device according to the disclosure;

FIG. 4 is a front-view sectional structural schematic diagram of the photocatalytic purification device according to the disclosure;

FIG. 5 is an enlarged schematic structural diagram of portion A shown in FIG. 4;

FIG. 6 is an enlarged schematic structural diagram of portion B shown in FIG. 5;

FIG. 7 is an enlarged schematic structural diagram of portion C shown in FIG. 4;

FIG. 8 is an enlarged schematic structural diagram of portion D shown in FIG. 7;

FIG. 9 is an enlarged schematic structural diagram of portion E shown in FIG. 4;

FIG. 10 is an enlarged schematic structural diagram of portion F shown in FIG. 4;

FIG. 11 is a top-view three-dimensional structural schematic diagram of an adsorption filtration net dredging mechanism, an electrostatic adsorption rod, a debris removal mechanism, and a filter bag flapping mechanism according to the disclosure;

FIG. 12 is a three-dimensional structural schematic diagram of another side of the photocatalytic purification device as shown in FIG. 11;

FIG. 13 is a bottom-view three-dimensional structural schematic diagram of the photocatalytic purification device as shown in FIG. 11;

FIG. 14 is a structural schematic diagram of the air and liquid supply of a solution reaction tank according to the disclosure; and

FIG. 15 is a front sectional structural schematic diagram of a portion as shown in FIG. 14.

### REFERENCE NUMERALS AND DENOTATIONS THEREOF

1—device frame; 2—filtration box; 3—catalytic purification box; 4—air intake pipe; 5—air intake connecting pipe; 6—air discharge connecting pipe; 7—induced draft fan; 8—air discharge pipe; 9—filtration chamber; 10—impurity collection chamber; 11—rectangular frame; 12—air filtration net; 13—filtration hole; 14—high-pressure air jet pipe; 15—impurity collection pipe; 16—air jet hood; 17—impurity collection hood; 18—connecting pipe I; 19—impurity discharge hose; 20—impurity collection filter bag; 21—flter bag access door; 22—air exhaust hole; 23—connecting pipe II; 24—air intake hose; 25—external connecting pipe; 26—control valve I; 27—control valve II; 28—fixing plate I; 29—fixing plate II; 30—guide strip plate; 31—horizontal movement screw; 32—synchronous wheel I; 33—synchronous belt I; 34—motor base; 35—driving motor; 36—activated carbon layer; 37—photocatalytic purification chamber; 38—spraying chamber; 39—photocatalytic lamp tube; 40—catalytic reaction layer; 41—guiding elbow pipe; 42—water filtration net; 43—water pump; 44—spraying pipe; 45—water distribution pipe; 46—atomizing nozzle; 47—sewage discharge pipe; 48—water replenishment pipe; 49—air guide plate; 50—operation door; 51—cleaning plate; 52—electrostatic adsorption rod; 53—dust-scraping sleeve plate; 54—synchronous plate; 55—brush sweeper; 56—camshaft; 57—flapping cam; 58—power transmission shaft; 59—bevel gear; 60—synchronous wheel II; 61—synchronous belt II; 62—tank mounting position; 63—solution reaction tank; 64—distributed air pipe; 65—distributed solution pipe; 66—ultraviolet lamp tube; 67—purified exhaust pipe; 68—clean air intake pipe; 69—air compression pump; 70—solution storage tank; 71—solution introduction pipe; 72—solution pump I; 73—solution return pipe; 74—solution pump II; and 75—solution replenishment pipe.

### DETAILED DESCRIPTION

Unless otherwise defined, all technical and scientific terms used herein have the same meaning as commonly understood by those skilled in the technical field to which the present application belongs. The terms used in the specification of the present application are intended solely for describing specific embodiments rather than limiting the present application. The terms “include” and “have” as well as any variations thereof used in the specification, claims, and the aforementioned descriptions of the accompanying drawings of the present application are intended to cover non-exclusive inclusions. The terms “first”, “second”, etc. in the specification, claims, or the aforementioned drawings of the present application are used to distinguish between different objects rather than indicating a specific sequence. The orientation or state relations indicated by the terms “inner”, “outer”, “left”, and “right” are based on those shown in the accompanying drawings and merely for the ease of describing the disclosure and simplifying the description, rather than indicating or implying that the device or element referred to must be in a specific orientation or constructed and operated in a specific orientation, and therefore cannot be interpreted as limiting the disclosure.

The mention of “embodiment” herein indicates that specific features, structures, or characteristics described in conjunction with the embodiment can be included in at least one embodiment of the present application. The appearance of this phrase in various locations throughout the specification does not necessarily refer to the same embodiment, nor does it imply that the embodiments are mutually exclusive, independent, or alternative to one another. It is explicitly and implicitly understood by those skilled in the art that the embodiments described herein may be combined with other embodiments.

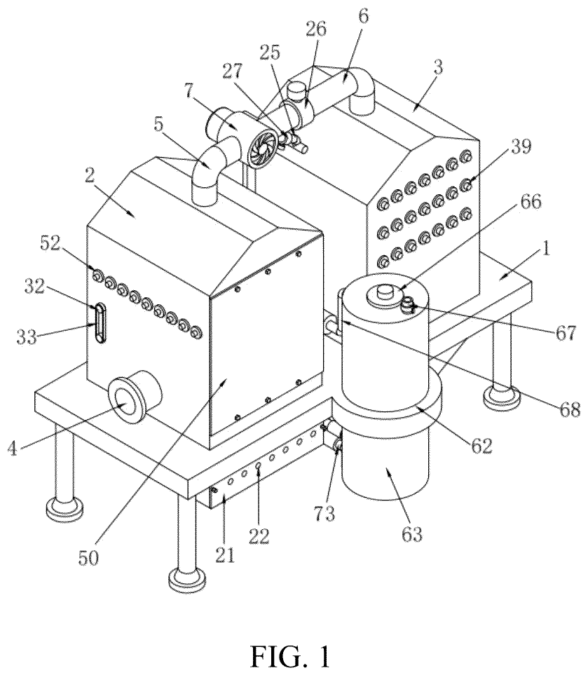

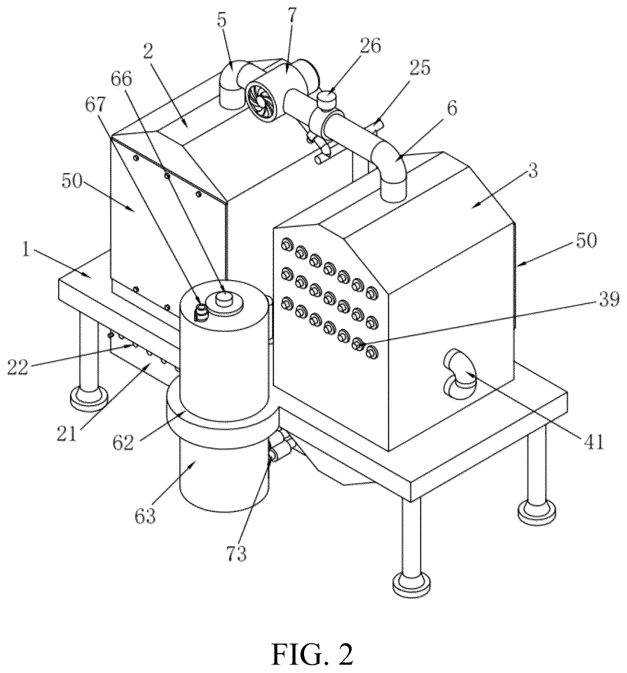

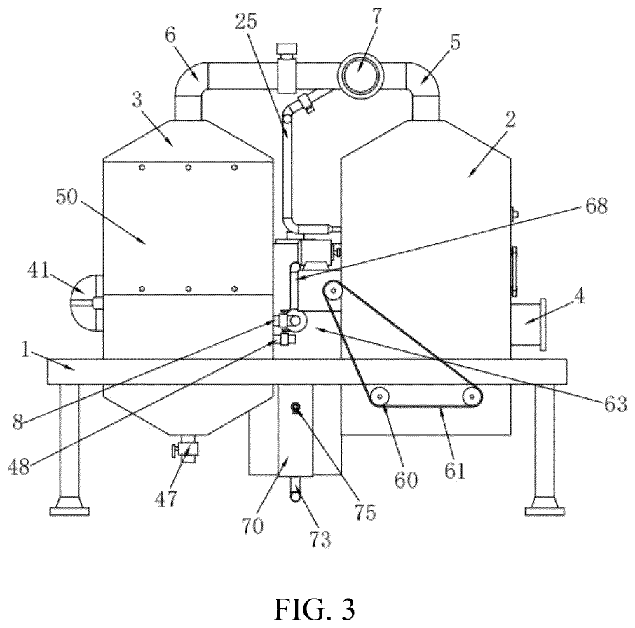

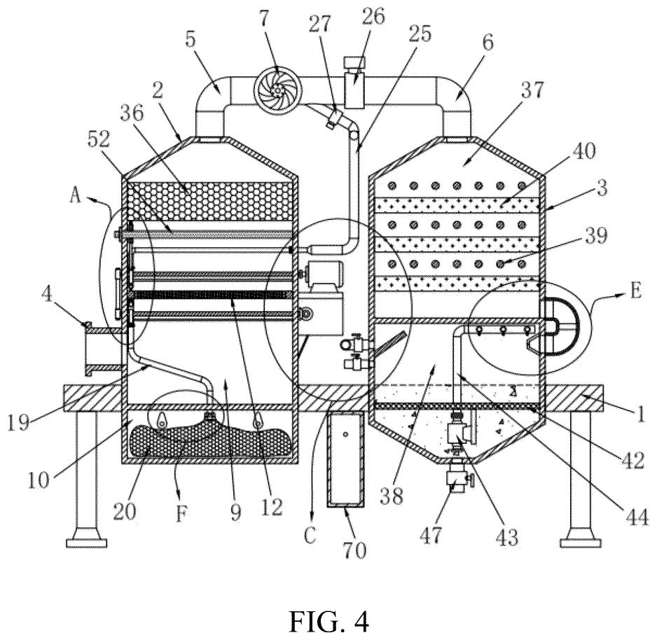

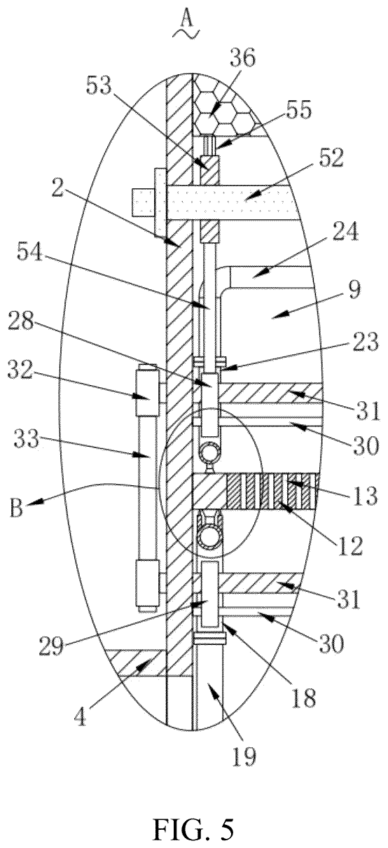

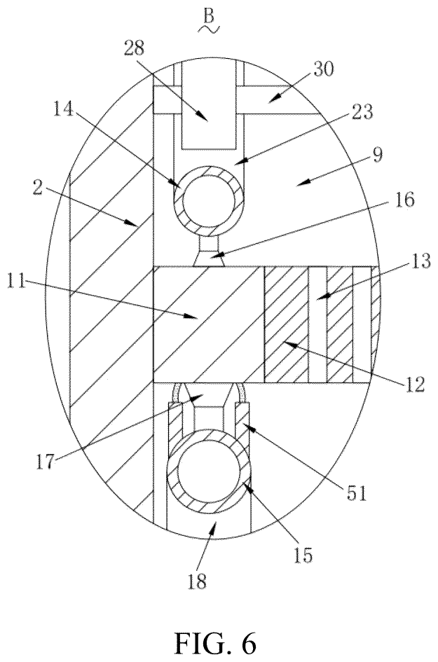

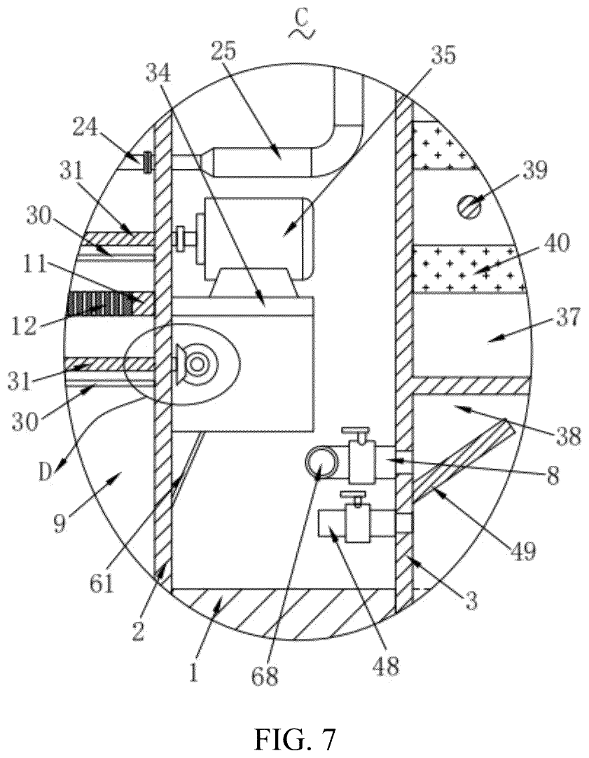

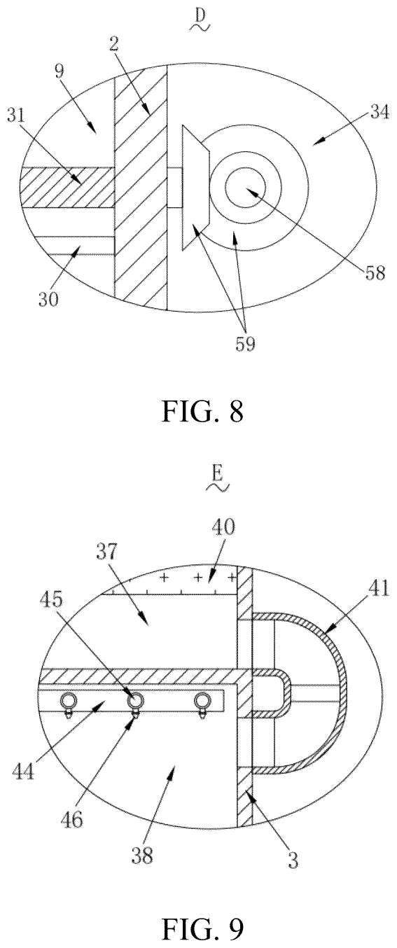

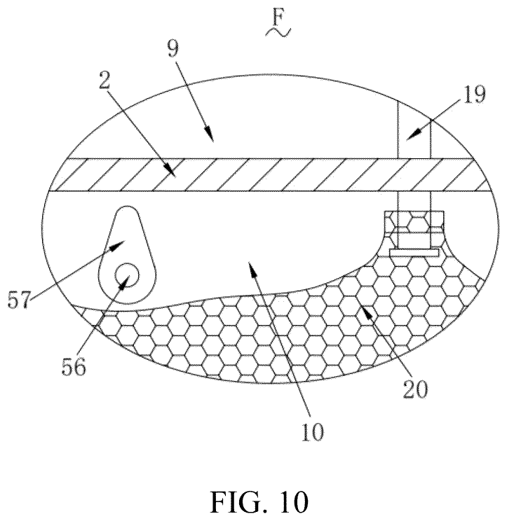

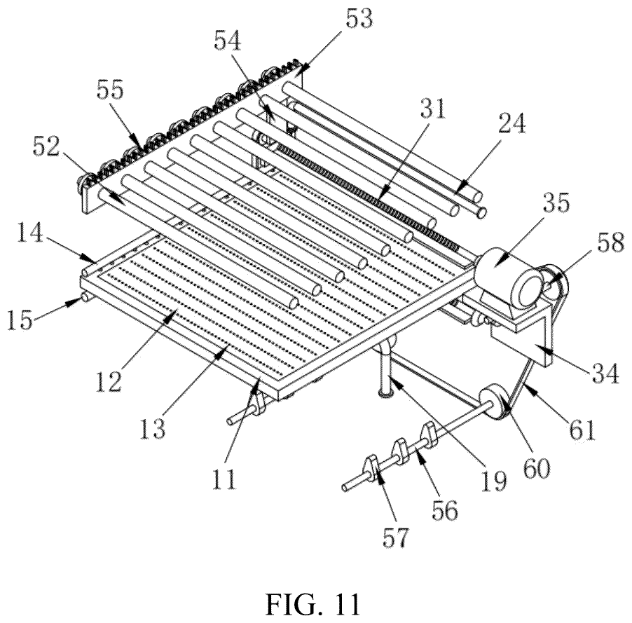

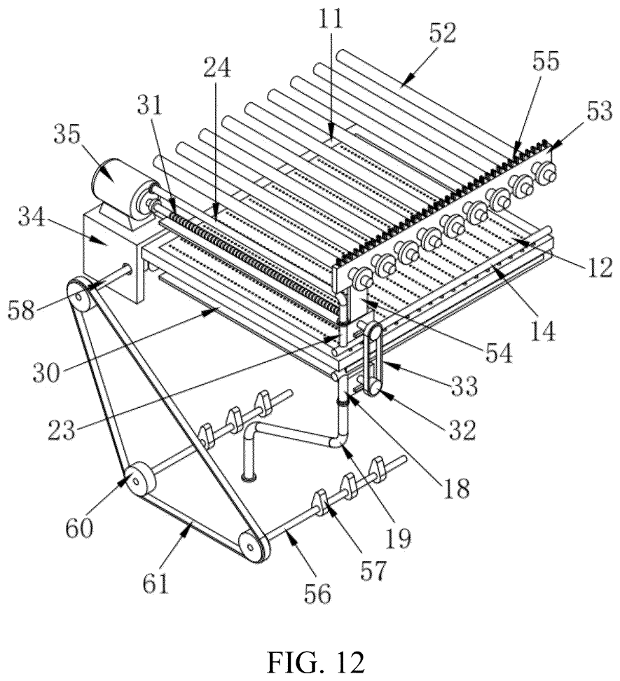

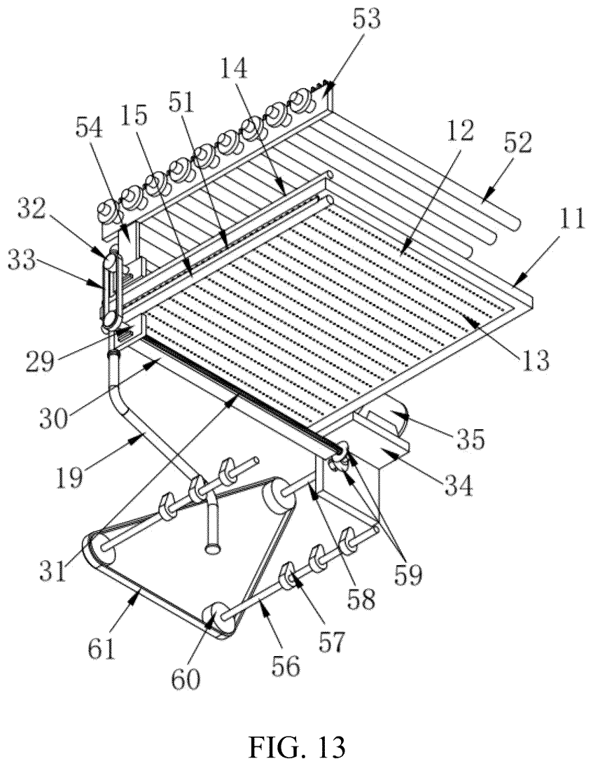

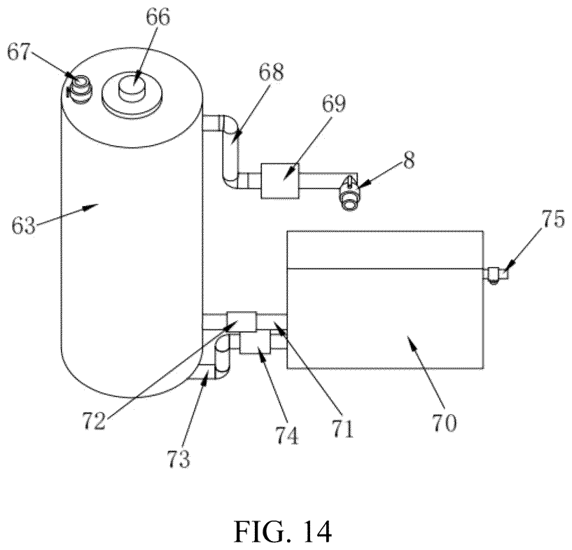

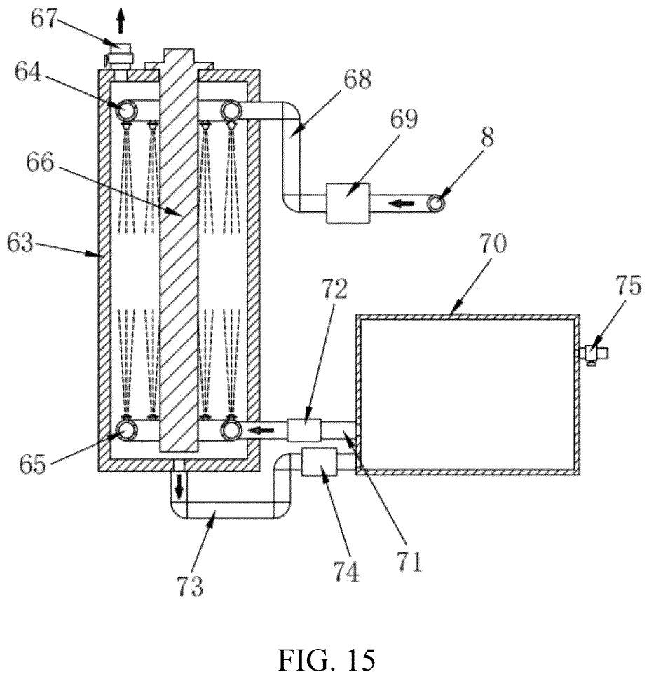

An embodiment of the disclosure provides a photocatalytic purification device, as shown in FIGS. 1-15. The photocatalytic purification device includes: a filtration box 2, a catalytic purification box 3, and a solution reaction tank 63 which are fixed on a device frame 1. The solution reaction tank 63 is mounted at a tank mounting position 62 of the device frame 1 and is used for purifying wastewater. The filtration box 2 and the catalytic purification box 3 are used in combination to purify waste gas. An air intake pipe 4 is arranged on one side of the filtration box 2. An air intake connecting pipe 5 and an air discharge connecting pipe 6 are arranged at a top of the filtration box 2 and a top of the catalytic purification box 3, respectively. The air intake connecting pipe 5 and the air discharge connecting pipe 6 are connected to a same induced draft fan 7 used for drawing filtered air from the filtration box 2 and discharging same into the catalytic purification box 3 for catalytic purification. An air discharge pipe 8 is arranged on one side of the catalytic purification box 3. The filtration box 2 is internally divided into a filtration chamber 9 and an impurity collection chamber 10. The filtration chamber 9 is in communication with the air intake pipe 4 and the air intake connecting pipe 5. The impurity collection chamber 10 is located at a bottom of the filtration box 2 and below the filtration chamber 9. The filtration chamber 9 and the impurity collection chamber 10 are not in communication. A rectangular frame 11 is included. The rectangular frame 11 is fixedly mounted inside the filtration chamber 9. An air filtration net 12 is fixedly mounted inside the rectangular frame 11. A plurality of filtration holes 13 are evenly distributed on the air filtration net 12, and the plurality of filtration holes 13 are arranged in a plurality of rows. An adsorption filtration net dredging mechanism is included. The adsorption filtration net dredging mechanism is arranged inside the filtration chamber 9, and is used for clearing the filtration holes 13 of the air filtration net 12. The air discharge pipe 8 is connected to the solution reaction tank 63 and is used for introducing clean air.

In this embodiment, during use, first, the device is connected to a power supply to start the induced draft fan 7. The air intake pipe 4 draws in the air to be purified, and the air enters the filtration chamber 9 inside the filtration box 2. Under the action of the induced draft fan 7, the filtered air is pumped through the air intake connecting pipe 5 to the catalytic purification box 3 for further catalytic purification treatment.

Inside the filtration chamber 9, the air is filtered by the air filtration net 12 fixed on the rectangular frame 11. The plurality of filtration holes 13 on the air filtration net 12 intercept particulate matter in the air, and the clean air continues to flow toward the air intake connecting pipe 5.

During the operation of the device, the adsorption filtration net dredging mechanism operates inside the filtration chamber 9 to unclog the filtration holes 13 of the air filtration net 12, preventing blockages. In the solution, by introducing high-pressure air from above and collecting impurities from below, the clearance of the filtration holes 13 is achieved. This method is distinguished from traditional methods that merely clean the surface. Impurities are uniformly collected into the impurity collection chamber 10, achieving better cleaning performance. This step ensures the sustained and efficient filtration capability of the air filtration net 12, and guarantees stable purification effects.

The wastewater is directed into the solution reaction tank 63 for catalytic purification. The solution reaction tank 63 utilizes the air filtered by the preceding stage to ensure the cleanliness of the purified air and enhance the effectiveness of catalytic purification. Therefore, the whole solution not only enables catalytic purification of air but also meets the requirements for purifying wastewater and other solutions, fulfilling multi-purpose needs.

In the above-described solution, the solution reaction tank 63 is internally arranged with a distributed air pipe 64 and a distributed solution pipe 65. Both the distributed air pipe 64 and the distributed solution pipe 65 are circular in shape. The distributed air pipe 64 is positioned above the distributed solution pipe 65. A plurality of nozzles are mounted on opposite sides of the distributed air pipe 64 and the distributed solution pipe 65, for spraying air and wastewater, respectively. Ultraviolet lamp tubes 66 inserted into both the distributed air pipe 64 and the distributed solution pipe 65 are arranged inside the solution reaction tank 63, used for catalyzing the wastewater. A purified exhaust pipe 67 is mounted above the solution reaction tank 63. The distributed air pipe 64 is connected to a clean air intake pipe 68. The clean air intake pipe 68 extends outside the solution reaction tank 63 and is connected to the air exhaust pipe 8. An air compression pump 69 is arranged on the clean air intake pipe 68. A solution storage tank 70 is fixedly mounted at the bottom of the device frame 1. The distributed solution pipe 65 is connected to a solution introduction pipe 71, and the solution introduction pipe 71 extends outside the solution reaction tank 63 and is connected to the solution storage tank 70. A solution pump I 72 is arranged on the solution introduction pipe 71 to pump a solution from the solution storage tank 70 into the distributed solution pipe 65. At the bottom of the solution reaction tank 63 and on the solution storage tank 70, a same solution return pipe 73 is connected. A solution pump II 74 is arranged on the solution return pipe 73, and is used for returning the solution from the solution reaction tank into the solution storage tank 70. A solution replenishment pipe 75 is arranged on the solution storage tank 70.

In this embodiment, the filtration box 2 and the catalytic purification box 3, which are fixed on the device frame 1, work in combination to purify waste gas. Moreover, the solution reaction tank 63 is used for wastewater purification. This design achieves the simultaneous treatment of waste gas and wastewater, enhancing the operational efficiency and processing capacity of the device.

The circular distributed design of the distributed air pipe 64 and the distributed solution pipe 65 inside the solution reaction tank 63, along with the use of ultraviolet lamp tubes 66, are all intended to facilitate non-equilibrium photocatalytic reaction, thereby improving the removal rates of ammonia nitrogen and chemical oxygen demand (COD).

During use, the air compression pump 69 draws clean air from the air discharge pipe 8 through the clean air intake pipe 68 and then ejects the clean air downward through a plurality of nozzles on the distributed air pipe 64. Moreover, wastewater is replenished into the solution storage tank 70 via the solution replenishment pipe 75. The wastewater is then transferred into the distributed solution pipe 65 through the solution introduction pipe 71 and the solution pump I 72, and subsequently is sprayed upward through the plurality of nozzles at the top of the distributed solution pipe 65. The air and liquid phases come into countercurrent contact at high velocity in the vertical direction, and the rapidly rotating upward liquid flow collides with the rapidly descending air flow, causing the liquid to envelop and carry a significant amount of pressurized air. As the amount of enveloped pressurized air continuously increases and expands outward, along with the segmentation and compression exerted by the high-speed descending air phase and the high-speed upward-spraying liquid phase, the air phase, which is continuously wrapped and separated by the liquid phase, forms a large number of bubbles and droplets. These bubbles and droplets are carried outward by the high-speed jetting liquid towards the reactor walls, then back to the center to come into contact again with the high-speed flowing air flow, entrapping a substantial amount of air phase to form new bubbles and droplets.

The continuously descending air and bubble layers impede the upward flow of the liquid phase; and conversely, the continuously upward-spraying liquid flow and bubble layers also hinder the downward flow of the air phase. When the air and liquid phases reach momentum equilibrium, a stable foam layer is formed. The numerous bubbles within the foam layer not only significantly increase the mass transfer area between the air and liquid phases but also rupture under the impact of the high-speed jetting liquid flow and the bidirectional compression of the air and liquid phases, thereby separating the air and liquid phases. This results in an extremely high renewal frequency of the foam, greatly enhancing the reaction and separation efficiency between the air and liquid phases, and thus endowing the device with high mass transfer and separation efficiency. The droplets also increase the contact area between the reaction liquid, the catalyst coating, and the ultraviolet lamp tubes 66, substantially improving the reaction efficiency. This device is suitable for the treatment of various types of wastewater, particularly the wastewater with high ammonia nitrogen content.

Reference is made to the content of the patent document CN 107051337 A for the specific catalyst coating and related operations mentioned above. This patent overcomes the biases of the prior art by first forming a foam layer from the wastewater and then combining this foam layer with photocatalytic reaction. Since the foam encapsulates gas, after the foam comes into contact with the light source and catalyst coating for reaction, the generated ammonia gas disrupts the equilibrium of the bubbles and causes them to rupture, thereby separating the gas and liquid phases. The foam within the reactor has an extremely high renewal frequency, allowing the ammonia gas to be carried away by the gas into the external environment, thus promoting the continuous rightward shift of the reaction, keeping the ammonia-nitrogen removal reaction in a non-equilibrium state. As the reaction consistently shifts to the right, the ammonia-nitrogen removal rate is significantly increased. In the disclosure, the ammonia nitrogen removal rate can reach 90% or higher, and therefore the device provided in the disclosure is particularly suitable for the treatment of wastewater having a high ammonia-nitrogen content. Additionally, the device of the disclosure also shows certain effectiveness in removing COD, with a COD removal rate of approximately 50%.

Compared with the prior art, the photocatalytic reaction device provided by the disclosure features a simple structure and is particularly suitable for the industrial treatment of wastewater having high ammonia-nitrogen content. The air and liquid phases come into countercurrent contact at high velocity in the vertical direction, ensuring that the reaction liquid fully contacts the light source and catalyst coating. This not only increases the contact area but also maintains the ammonia nitrogen removal reaction in a non-equilibrium state during the foam layer reaction, continuously driving the reaction towards the generation of ammonia air and enhancing the reaction efficiency. The processing capacity and reaction efficiency far surpass those of ultrasonic atomization methods.

The overall solution not only enables catalytic purification of air but also meets the requirements for purifying wastewater and other solutions, fulfilling multi-purpose needs.

In summary, the photocatalytic purification device in the embodiment, through the incorporation of a non-equilibrium photocatalytic reaction device design, not only improves the removal efficiency of ammonia nitrogen and COD, but also features a simple structure suitable for industrial treatment, offering broad application prospects.

In a preferred embodiment of the disclosure, the adsorption filtration net dredging mechanism includes a high-pressure air jet pipe 14 and an impurity collection pipe 15; the high-pressure air jet pipe 14 and the impurity collection pipe 15 are slidably arranged at an upper part of the rectangular frame 11 and at a lower part of the air filtration net 12, respectively, and the high-pressure air jet pipe 14 and the impurity collection pipe 15 are capable of sliding horizontally along a direction in which the filtration holes 13 of the air filtration net 12 are arranged; a plurality of air jet hoods 16 are arranged at a bottom of the high-pressure air jet pipe 14, and a plurality of impurity collection hoods 17 are arranged at a top of the impurity collection pipe 15; the number of the air jet hoods 16 and the impurity collection hoods 17 is the same as the number of rows of the filtration holes 13, with corresponding positions; the corresponding air jet hoods 16 and impurity collection hoods 17 are located on a same vertical line, enabling to simultaneously block same filtration holes 13; and a diameter of an opening of the air jet hood 16 is larger than a diameter of the filtration hole 13, and a diameter of an opening of the impurity collection hood 17 is larger than the diameter of the opening of the air jet hood 16.

In this embodiment, when cleaning the air filtration net 12, the high-pressure air jet pipe 14 and the impurity collection pipe 15 slide above the rectangular frame 11 and below the air filtration net 12, respectively. The two pipes move horizontally along the distribution direction of the filtration holes 13 of the air filtration net 12, ensuring that each filtration hole 13 receives dredging treatment.

The plurality of air jet hoods 16 at the bottom of the high-pressure air jet pipe 14 sequentially align with the top of each of the filtration holes 13 as the pipe moves. When the air jet hoods 16 align with the filtration holes 13, the high-pressure air is ejected from the air jet hoods 16. The impact force of the air flow is utilized to dredge the filtration holes 13 and remove impurities clogging the holes.

The impurity collection pipe 15, which moves synchronously with the high-pressure air jet pipe 14, has a plurality of impurity collection hoods 17 at its top that sequentially align with the bottom of each dredged filtration hole 13. The diameter of the opening of the impurity collection hood 17 is larger than that of the air jet hood 16, it ensures that the dredged impurities and particulate matter are effectively collected into the impurity collection hoods 17 and then transported through the impurity collection pipe 15 to the impurity collection chamber 10 for unified treatment.

With the arrangement of the high-pressure air jet pipe 14 and the air jet hood 16, the impact force of high-pressure air flow is utilized to dredge the filtration holes 13, significantly improving the dredging efficiency and ensuring the sustained and efficient filtration capability of the air filtration net 12.

The design of the impurity collection pipe 15 and the impurity collection hood 17 enables precise collection of the dredged impurities and particulate matter into the impurity collection chamber 10, preventing secondary pollution from impurities and problems of device blockage.

The sliding arrangement of the high-pressure air jet pipe 14 and the impurity collection pipe 15, along with the corresponding arrangement of the air jet hood 16 and the impurity collection hood 17, achieves a compact and stable dredging mechanism, effectively enhancing the overall performance and reliability of the device.

In a preferred embodiment of the disclosure, the adsorption filtration net dredging mechanism further includes a connecting pipe I 18, an impurity discharge hose 19, an impurity collection filter bag 20, a high-pressure air introduction mechanism, and a horizontal driving power mechanism; the connecting pipe I 18 is connected to the impurity collection pipe 15, and the impurity discharge hose 19 is connected to the connecting pipe I 18, with an impurity discharge end extending into the impurity collection chamber 10; the impurity collection filter bag 20 is arranged inside the impurity collection chamber 10, and an opening of the impurity collection filter bag 20 is sleeved on the impurity discharge end of the impurity discharge hose 19; and a filter bag access door 21 is detachably mounted on one side of the bottom of the filtration box 2, and an air exhaust hole 22 is disposed on the filter bag access door 21.

In this embodiment, after the impurity collection pipe 15 gathers impurities, the impurities are transferred to the impurity collection filter bag 20 inside the impurity collection chamber 10 via the connecting pipe I 18 and the impurity discharge hose 19. The opening of the impurity collection filter bag 20 is tightly sleeved on the impurity discharge end of the impurity discharge hose 19, ensuring that impurities do not leak while allowing air circulation.

The impurities are stored within the impurity collection filter bag 20. Moreover, the impurity collection filter bag 20 also achieves secondary filtration. As impurities accumulate, the impurity collection filter bag 20 gradually becomes saturated.

Once the impurity collection filter bag 20 reaches a certain level of saturation, the operator can easily remove and replace the impurity collection filter bag 20 by opening the filter bag access door 21. The design of the filter bag access door 21 facilitates easy operation, and the air exhaust hole 22 on the filter bag access door 21 allows the air inside the impurity collection chamber 10 to be expelled, preventing accumulation of pressure.

In a preferred embodiment of the disclosure, the high-pressure air introduction mechanism includes a connecting pipe II 23, an air intake hose 24, an external connecting pipe 25, a control valve I 26, and a control valve II 27; the connecting pipe II 23 is connected to the high-pressure air jet pipe 14, and the air intake hose 24 is connected to the connecting pipe II 23; the external connecting pipe 25 penetrates through a wall of the filtration box 2, with an air intake end connected to the air discharge connecting pipe 6, and an air exhaust end connected to an air intake end of the air intake hose 24; and the control valve I 26 is arranged on the air discharge connecting pipe 6, an air intake end of the external connecting pipe 25 is arranged between the induced draft fan 7 and the control valve I 26, and the control valve II 27 is arranged on the external connecting pipe 25.

In this embodiment, the high-pressure air enters the connecting pipe II 23 through the air intake hose 24 and is subsequently introduced into the high-pressure air jet pipe 14. During this process, the external connecting pipe 25 plays a crucial role as a bridge linking the air discharge connecting pipe 6 and the air intake hose 24. There is no concern about secondary pollution by using the filtered and clean air. The air intake end of the external connecting pipe 25 is positioned between the induced draft fan 7 and the control valve I 26, ensuring that the high-pressure air can smoothly enter the external connecting pipe 25 under the action of the induced draft fan 7. When cleaning is not required, the control valve II 27 can be closed, and the control valve I 26 can be fully opened. During cleaning, the control valve I 26 is adjusted to a smaller opening, and the control valve II 27 is opened.

The control valve I 26 and the control valve II 27 are respectively arranged on the air discharge connecting pipe 6 and the external connecting pipe 25 to regulate the flow rate and pressure of the high-pressure air. By adjusting the openings of the two control valves, the amount of high-pressure air entering the high-pressure air jet pipe 14 can be precisely controlled, thereby achieving fine-tuning of the dredging effect on the filtration net.

The regulated high-pressure air is ejected from the air jet hood 16 at the bottom of the high-pressure air jet pipe 14, dredging the filtration holes 13 of the air filtration net 12. This process not only removes impurities clogging the filtration holes 13 but also further enhances the filtration efficiency of the air filtration net 12 through the scouring action of the high-pressure air flow.

The high-pressure air is evenly ejected onto the filtration holes 13 through the air jet hoods 16, which not only removes blockages but also enhances the filtration efficiency of the filtration net through scouring action, thereby extending the service life of the filtration net.

In a preferred embodiment of the disclosure, the horizontal driving power mechanism includes a fixing plate I 28, a fixing plate II 29, two guide strip plates 30, two horizontal movement screws 31, two synchronous wheels I 32, a synchronous belt I 33, a motor base 34, and a driving motor 35; the fixing plate I 28 and the fixing plate II 29 are fixedly mounted on the connecting pipe II 23 and the connecting pipe I 18, respectively; the two guide strip plates 30 slide through the fixing plate I 28 and the fixing plate II 29, respectively, with two ends of each of the two guide strip plates 30 fixedly connected to inner walls of two sides of the filtration chamber 9; the two horizontal movement screws 31 are threaded through the fixing plate I 28 and the fixing plate II 29 in a driving manner, respectively, with two ends of each of the two horizontal movement screws 31 rotatably connected to the inner walls on the two sides of the filtration chamber 9, respectively, two ends of each of the two horizontal movement screws 31 extend outside the filtration box 2, and the guide strip plates 30 and the horizontal movement screws 31 are arranged in a same direction; the two synchronous wheels I 32 are fixedly mounted at same ends of the two horizontal movement screws 31, and the synchronous belt I 33 is looped around the two synchronous wheels I 32; and the motor base 34 is fixedly mounted on one side of the filtration box 2, the driving motor 35 is fixedly mounted on the motor base 34, and an output shaft of the driving motor 35 is fixedly connected to an end of a corresponding horizontal movement screw 31.

In this embodiment, the fixing plate I 28 and the fixing plate II 29 are fixedly mounted on the connecting pipe II 23 and the connecting pipe I 18, respectively, serving as supporting structures for a horizontal driving power mechanism. The two horizontal movement screws 31 also penetrate through the fixing plate I 28 and the fixing plate II 29 in a threaded manner, and are rotatably connected to the inner walls of two sides of the filtration chamber 9, providing power for horizontal movement.

The driving motor 35 is fixedly mounted on one side of the filtration box 2 via the motor base 34, and an output shaft of the driving motor 35 is fixedly connected to an end of one of the horizontal movement screws 31. When the driving motor 35 is activated, it drives the horizontal movement screws 31 to rotate. Synchronous wheels I 32 are fixedly mounted on the same ends of the two horizontal movement screws 31 and are connected via a synchronous belt I 33. Therefore, when one of the horizontal movement screws 31 rotates, it drives the other horizontal movement screw 31 to rotate synchronously. In this way, the two horizontal movement screws 31 can drive the connecting pipe I 23 and the connecting pipe II 18 (along with the high-pressure air jet pipe 14 and the impurity collection pipe 15 mounted thereon) to move horizontally at the same speed and in the same direction, guided by the guide strip plates 30.

In a preferred embodiment of the disclosure, the high-pressure air jet pipe 14, the impurity collection pipe 15, the connecting pipe I 18, and the connecting pipe II 23 are all rigid pipes, and a frame edge width of the rectangular frame 11 is greater than a width of the high-pressure air jet pipe 14, the impurity collection pipe 15, the connecting pipe I 18, the connecting pipe II 23, the fixing plate I 28, and the fixing plate II 29.

In this embodiment, the high-pressure air jet pipe 14, the impurity collection pipe 15, the connecting pipe I 18, and the connecting pipe II 23 are all rigid pipes. Rigid pipes feature stable structure, resistance to deformation, and strong pressure-bearing capacity, ensuring the smooth transmission of air and impurities while also providing firm support for the entire dredging mechanism.

The frame edge width of the rectangular frame 11 is designed to be greater than the width of all the aforementioned rigid pipes. This design ensures that when not in operation, the high-pressure air jet pipe 14, the impurity collection pipe 15, the connecting pipe I 18, the connecting pipe II 23, the fixing plate I 28, and the fixing plate II 29 can be concealed in corners.

In a preferred embodiment of the disclosure, a diameter of the external connecting pipe 25 is larger than that of the air intake hose 24, an air intake end of the external connecting pipe 25 is inclined in a windward direction, and the windward direction refers to a direction from an air outlet end of the induced draft fan 7 to an air exhaust end of the air discharge connecting pipe 6.

In this embodiment, the diameter of the external connecting pipe 25 is designed to be greater than that of the air intake hose 24. This design has two main purposes: one is to reduce the air flow resistance within the pipes, enabling high-pressure air to flow more smoothly from the air discharge connecting pipe 6, through the external connecting pipe 25, and into the air intake hose 24, before finally entering the high-pressure air jet pipe 14; and the other is to create an air flow buffer zone within the external connecting pipe 25, which helps stabilize the air flow pressure and flow rate, preventing direct impact on the air intake hose 24 that can cause damage or affect the dredging effect.

The air intake end of the external connecting pipe 25 is inclined in a windward direction, and the windward direction refers to a direction from the air outlet end of the induced draft fan 7 to the air exhaust end of the air discharge connecting pipe 6. This design is intended to better capture and utilize the air flow generated by the induced draft fan 7, allowing the high-pressure air to enter the external connecting pipe 25 more efficiently. The inclined air intake end also guides the air flow to flow along the inner wall of the pipe, reducing vortex and turbulence, thereby further enhancing the stability and efficiency of the air flow.

The high-pressure air introduction mechanism and the horizontal driving power mechanism work together to achieve precise dredging of the air filtration net 12 and impurity collection. During this process, the optimized design of the external connecting pipe 25 further improves the efficiency and stability of high-pressure air introduction, ensuring consistent and reliable dredging results.

In a preferred embodiment of the disclosure, rectangular sliding openings and threaded holes are disposed on the fixing plate I 28 and the fixing plate II 29, the guide strip plates 30 slide through corresponding rectangular sliding openings, and the horizontal movement screws 31 penetrate through corresponding threaded holes in a threaded engagement manner.

In this embodiment, the design of the rectangular sliding openings and the threaded holes, along with the sliding mounting of the guide strip plates 30 within the rectangular sliding openings and the threaded engagement connection of the horizontal movement screws 31, collectively ensure precise guiding and stable movement of the horizontal movement mechanism. This guarantees the accurate dredging and impurity collection of the high-pressure air jet pipe 14 and the impurity collection pipe 15 on the air filtration net 12.

In a preferred embodiment of the disclosure, an activated carbon layer 36 is detachably mounted inside the filtration chamber 9, and the activated carbon layer 36 is positioned above the air filtration net 12 and the adsorption filtration net dredging mechanism.

In this embodiment, a detachable activated carbon layer 36 is designed within the filtration chamber 9. This design allows for easy mounting and removal of the activated carbon layer 36, enabling users to replace or clean according to actual needs, thereby maintaining the excellent filtration performance of the activated carbon layer 36.

The activated carbon layer 36 is positioned above the air filtration net 12 and the adsorption filtration net dredging mechanism. This ensures that the air, after passing through the air filtration net 12, undergoes further filtration by the activated carbon layer 36, effectively removing impurities such as odors and harmful gas from the air.

In a preferred embodiment of the disclosure, the catalytic purification box 3 is internally divided into a photocatalytic purification chamber 37 at an upper part and a spraying chamber 38 at a lower part, the photocatalytic purification chamber 37 is in communication with the air discharge connecting pipe 6, and the spraying chamber 38 is in communication with the air discharge pipe 8; a plurality of rows of photocatalytic lamp tubes 39 and catalytic reaction layers 40 are mounted inside the photocatalytic purification chamber 37 in a staggered manner, to catalyze and purify air; and the photocatalytic purification chamber 37 and the spraying chamber 38 are in communication via a guiding elbow pipe 41.

In this embodiment, the interior of the catalytic purification box 3 is ingeniously divided into the photocatalytic purification chamber 37 at the upper part and the spraying chamber 38 at the lower part. The photocatalytic purification chamber 37 is in communication with the air discharge connecting pipe 6, and is used for receiving the air to be purified from the air discharge connecting pipe 6. The spraying chamber 38 is in communication with the air discharge pipe 8, and is used for discharging the purified air. Meanwhile, the photocatalytic purification chamber 37 and the spraying chamber 38 are communicated via the guiding elbow pipe 41, ensuring the smooth flow of air between the two chambers.

Inside the photocatalytic purification chamber 37, a plurality of rows of photocatalytic lamp tubes 39 and catalytic reaction layers 40 are mounted in a staggered manner. The photocatalytic lamp tubes 39 emit light of specific wavelengths to activate the catalysts on the catalytic reaction layers 40, so that intense oxidation-reduction reaction is generated, thereby catalyzing and purifying the harmful substances in the air.

Spraying is arranged inside the spraying chamber 38. When air enters the spraying chamber 38 from the photocatalytic purification chamber 37 through the guiding elbow pipe 41, a spraying device will spray a purification liquid into the air. This further removes residual impurities and odors from the air. Finally, the purified air is discharged through the air discharge pipe 8.

To further enhance the performance of the device, in addition to the aforementioned features, the solution also includes the following embodiment.

In another embodiment of the disclosure, a water filtration net 42 is fixedly mounted inside the spraying chamber 38; the mounting height of the water filtration net 42 is lower than that of the air discharge pipe 8 and the guiding elbow pipe 41; a water pump 43 is mounted below the water filtration net 42, and a spraying pipe 44 is mounted at a water discharge end of the water pump 43; the spraying pipe 44 extends to a position above the exhaust end of the guiding elbow pipe 41 and is arranged with a water distribution pipe 45; a plurality of atomizing nozzles 46 are mounted on the water distribution pipe 45; a sewage discharge pipe 47 is mounted at the bottom of the catalytic purification box 3, and the sewage discharge pipe 47 is in communication with the spraying chamber 38; and a water replenishment pipe 48 is mounted on a side of the catalytic purification box 3, and the water replenishment pipe 48 is in communication with the spraying chamber 38.

In this embodiment, a water filtration net 42 is fixedly mounted inside the spraying chamber 38, with a mounting height thereof being lower than that of the air discharge pipe 8 and the guiding elbow pipe 41, ensuring that the purified air will not carry water droplets when being discharged. A water pump 43 is mounted below the water filtration net 42, and is used for pumping the accumulated water from the spraying chamber 38, and the accumulated water is recycled through the spraying pipe 44 connected to the water drainage end.

The spraying pipe 44 extends to a position above the air exhaust end of the guiding elbow pipe 41, and a water distribution pipe 45 is mounted, and a plurality of atomizing nozzles 46 are arranged on the water distribution pipe 45. This design allows the water pumped by the water pump 43 to pass through the spraying pipe 44 and the water distribution pipe 45, and finally the water is evenly sprayed in an atomized form onto the air entering the spraying chamber 38 through the guiding elbow pipe 41, further removing residual impurities from the air.

To maintain the cleanliness of the water quality in the spraying chamber 38, a sewage discharge pipe 47 is mounted at the bottom of the catalytic purification box 3. The sewage discharge pipe 47 is in communication with the spraying chamber 38 to discharge the accumulated debris. Moreover, a water replenishment pipe 48 is mounted on a side of the catalytic purification box 3, and is also in communication with the spraying chamber 38. The water replenishment pipe 48 is used for replenishing fresh water sources, ensuring the continuous and stable operation of a spraying system.

Through the interception of the water filtration net 42, the recycling by the water pump 43, and the even spraying of the atomizing nozzles 46, residual impurities and odors in the air are further removed, enhancing the purification effect.

In another embodiment of the disclosure, an air guide plate 49 is fixedly mounted inside the spraying chamber 38, the air guide plate 49 is positioned in correspondence with the air discharge pipe 8; one side of both the filtration box 2 and the catalytic purification box 3 is detachably mounted with an operation door 50, and the two operation doors 50 correspond to the filtration chamber 9 and the photocatalytic purification chamber 37, respectively.

In this embodiment, an air guide plate 49 is fixedly mounted inside the spraying chamber 38, and the air guide plate 49 is arranged in correspondence with the air discharge pipe 8. The air guide plate 49 serves to direct the air that has undergone spraying and purification towards the air discharge pipe 8, preventing the incoming air from directly rushing in. The inclined arrangement blocks some of the water vapor.

To facilitate users in performing maintenance and cleaning the interiors of the filtration box 2 and the catalytic purification box 3, an operation door 50 is detachably mounted on one side of both the filtration box 2 and the catalytic purification box 3, respectively. The two operation doors 50 correspond to the filtration chamber 9 and the photocatalytic purification chamber 37, respectively, enabling users to easily open the operation doors 50 and access the filtration chamber 9 and the photocatalytic purification chamber 37 for necessary maintenance.

In another embodiment of the disclosure, two cleaning plates 51 are fixedly mounted at the top of the impurity collection pipe 15, the two cleaning plates 51 are positioned on two sides of the plurality of impurity collection hoods 17, and the two cleaning plates 51 are used for sweeping a lower surface of the air filtration net 12 as the impurity collection pipe 15 moves horizontally.

In this embodiment, two cleaning plates 51 are fixedly mounted at the top of the impurity collection pipe 15. The two cleaning plates 51 are positioned on two sides of each of the plurality of impurity collection hoods 17, ensuring that when the impurity collection pipe 15 moves horizontally, the cleaning plates 51 can fully come into contact with and clean the lower surface of the air filtration net 12.

When the impurity collection pipe 15 moves horizontally driven by the driving mechanism, the cleaning plates 51 move along with it. The bottom edges of the cleaning plates 51 maintain a certain contact pressure against the lower surface of the air filtration net 12, effectively sweeping off dust, impurities, and other substances adhered to the lower surface of the air filtration net 12.

The introduction of the cleaning plates 51 achieves automatic cleaning of the lower surface of the air filtration net 12. This not only reduces the frequency and difficulty of manual cleaning but also improves cleaning efficiency, ensuring the continuous and efficient filtration performance of the air filtration net 12.

Regularly cleaning the lower surface of the air filtration net 12 can effectively prevent the accumulation of dust and impurities on the filtration net, thereby avoiding blockage and damage on the filtration net. This helps to extend the service life of the air filtration net 12 and reduce replacement costs.

In another embodiment of the disclosure, a plurality of electrostatic adsorption rods 52 are arranged below the activated carbon layer 36, and the plurality of electrostatic adsorption rods 52 are detachably mounted inside the filtration chamber 9; a debris removal mechanism is arranged inside the filtration chamber 9, and the debris removal mechanism includes a dust-scraping sleeve plate 53 slidably sleeved on the plurality of electrostatic adsorption rods 52; a synchronous plate 54 is fixedly mounted at a bottom of the dust-scraping sleeve plate 53, and a bottom of the synchronous plate 54 is fixedly connected to the fixing plate I 28; and a brush sweeper 55 is mounted at a top of the dust-scraping sleeve plate 53, and the brush sweeper 55 is in contact with a bottom of the activated carbon layer 36.

In this embodiment, to further enhance the air purification effect and improve the maintenance convenience of the device, a plurality of electrostatic adsorption rods 52 are arranged below the activated carbon layer 36, and these electrostatic adsorption rods 52 are all detachably mounted inside the filtration chamber 9. Additionally, the debris removal mechanism includes a dust-scraping sleeve plate 53 slidably sleeved on the plurality of electrostatic adsorption rods 52. The bottom of the dust-scraping sleeve plate 53 is fixedly connected to the fixing plate I 28 via the synchronous plate 54. The brush sweeper 55 is mounted at the top of the dust-scraping sleeve plate 53 to keep in contact with the bottom of the activated carbon layer 36.

By introducing the electrostatic adsorption rods 52, the principle of electrostatic adsorption is utilized to efficiently adsorb tiny particles and harmful substances in the air, further enhancing the air purification effect. Moreover, the detachable design of the electrostatic adsorption rods 52 allows users to easily clean or replace them to maintain their continuous adsorption capacity.

The design of the debris removal mechanism enables the dust-scraping sleeve plate 53 to slide along the plurality of electrostatic adsorption rods 52 by moving the synchronous plate 54, thus using the brush sweeper 55 to clean the bottom of the activated carbon layer 36. This design not only simplifies the maintenance process but also improves maintenance efficiency, ensuring the continuous and stable operation of the device.

In another embodiment of the disclosure, a filter bag flapping mechanism is arranged on the filtration box 2; the filter bag flapping mechanism includes a camshaft 56 that is rotatably mounted on a side of the impurity collection chamber 10 opposite to the filter bag access door 21; a flapping cam 57 is fixedly mounted on a segment of the camshaft 56 located inside the impurity collection chamber 10, designed to flap the impurity collection filter bag 20 inflated by air flow; a power transmission shaft 58 is rotatably mounted on the motor base 34; both the power transmission shaft 58 and the corresponding horizontal movement screw 31 are fixedly sleeved with bevel gears 59, and the two bevel gears 59 are meshed with each other; and synchronous wheels II 60 are fixedly mounted at an end of the camshaft 56 located outside the filtration box 2 and on the power transmission shaft 58, and a same synchronous belt II 61 is looped around a plurality of synchronous wheels II 60.

In this embodiment, to enhance the dust cleaning efficiency of the impurity collection filter bag 20 and ensure continuous and efficient air purification capability, a filter bag flapping mechanism is designed and integrated into the filtration box 2. The core components of the mechanism include a camshaft 56 rotatably mounted inside the impurity collection chamber 10, and a flapping cam 57 is fixedly mounted on the camshaft 56. In addition, a power transmission shaft 58 is rotatably mounted on the motor base 34, power transmission is achieved between the power transmission shaft 58 and the horizontal movement screws 31 achieve via bevel gears 59, and synchronous rotation is achieved between the camshaft 56 and the power transmission shaft 58 via the synchronous wheels II 60 and a synchronous belt II 61. When the driving motor 35 drives the horizontal movement screws 31 to rotate, it will drive the power transmission shaft 58 and the camshaft 56 to rotate synchronously, thereby driving the flapping cam 57 to flap the impurity collection filter bag 20 inflated by air flow.

The design of the filter bag flapping mechanism enables the impurity collection filter bag 20 to be flapped by the flapping cam 57 while being air-inflated, effectively removing the dust and impurities adhered to the filter bag, and improving the dust cleaning efficiency, thereby extending the service life of the filter bag and reducing the replacement frequency.

By utilizing the power transmission path of the horizontal movement screws 31 and combining transmission components such as bevel gears 59, the synchronous wheels II 60, and the synchronous belt II 61, the linkage between the filter bag flapping mechanism and the horizontal movement mechanism is achieved, enabling the entire device with more comprehensive functions while maintaining a compact structure.

In summary, compared with the prior art, the adsorption filtration net dredging mechanism is used in the device to unclog the filtration holes 13 of the air filtration net 12, preventing blockages. By introducing high-pressure air from above and collecting impurities from below, the clearance of the filtration holes 13 is achieved. This method is distinguished from traditional methods that merely clean the surface. Impurities are uniformly collected into the impurity collection chamber 10, achieving better cleaning performance. This step ensures the sustained and efficient filtration capability of the air filtration net 12, and guarantees stable purification effects. Additionally, the overall solution not only enables catalytic purification of air but also meets the requirements for purifying wastewater and other solutions, fulfilling multi-purpose needs.

In the disclosure, the photocatalytic purification device described above is applied to the treatment of wastewater and waste gas.

In the several embodiments provided in the present application, it is to be understood that a device disclosed can be realized in other ways.

The above-described embodiments are used solely to illustrate the technical solutions of the disclosure, rather than limiting the scope of protection of the disclosure. Obviously, the embodiments described are only some rather than all embodiments of the disclosure. On the basis of the embodiments, all other embodiments obtained by those ordinary skilled in the art without creative efforts are included in the scope of protection of the disclosure. Although the disclosure has been described in detail with reference to the aforementioned embodiments, those skilled in the art can still, without conflicting with the core concepts and without exerting creative effort, combine, add, delete, or make other adjustments to the features in various embodiments of the disclosure as appropriate, so as to obtain different technical solutions that essentially do not deviate from conception of the disclosure. These technical solutions also fall within the scope of protection claimed by the disclosure.

1. A photocatalytic purification device, comprising:
a filtration box, a catalytic purification box, and a solution reaction tank which are fixed on a device frame, wherein the solution reaction tank is mounted at a tank mounting position of the device frame and is used for purifying wastewater, the filtration box and the catalytic purification box are used in combination to purify waste gases, an air intake pipe is arranged on one side of the filtration box, an air intake connecting pipe and an air discharge connecting pipe are arranged at a top of the filtration box and a top of the catalytic purification box, respectively, and the air intake connecting pipe and the air discharge connecting pipe are connected to a same induced draft fan used for drawing filtered air from the filtration box and discharging same into the catalytic purification box for catalytic purification; and an air discharge pipe is arranged on one side of the catalytic purification box, and the air discharge pipe is connected to the solution reaction tank to introduce purified air; and
the filtration box is internally divided into a filtration chamber and an impurity collection chamber, the filtration chamber is in communication with the air intake pipe and the air intake connecting pipe, and the impurity collection chamber is located at a bottom of the filtration box and below the filtration chamber, and the filtration chamber and the impurity collection chamber are not in communication;
a rectangular frame, wherein the rectangular frame is fixedly mounted inside the filtration chamber, an air filtration net is fixedly mounted inside the rectangular frame, a plurality of filtration holes are evenly distributed on the air filtration net, and the plurality of filtration holes are arranged in a plurality of rows;
an adsorption filtration net dredging mechanism, wherein the adsorption filtration net dredging mechanism is arranged inside the filtration chamber, and is used for clearing the filtration holes of the air filtration net;
the adsorption filtration net dredging mechanism comprises a high-pressure air jet pipe and an impurity collection pipe, the high-pressure air jet pipe and the impurity collection pipe are slidably arranged at an upper part of the rectangular frame and at a lower part of the air filtration net, respectively, and the high-pressure air jet pipe and the impurity collection pipe are capable of sliding horizontally along a direction in which the filtration holes of the air filtration net are arranged; a plurality of air jet hoods are arranged at a bottom of the high-pressure air jet pipe, and a plurality of impurity collection hoods are arranged at a top of the impurity collection pipe; the number of the air jet hoods and the impurity collection hoods is the same as the number of rows of the filtration holes, with corresponding positions; corresponding air jet hoods and impurity collection hoods are located on a same vertical line, enabling to simultaneously block same filtration holes; and a diameter of an opening of the air jet hood is larger than a diameter of the filtration hole, and a diameter of an opening of the impurity collection hood is larger than the diameter of the opening of the air jet hood; and
the adsorption filtration net dredging mechanism further comprises a connecting pipe I, an impurity discharge hose, an impurity collection filter bag, a high-pressure air introduction mechanism, and a horizontal driving power mechanism; the connecting pipe I is connected to the impurity collection pipe, and the impurity discharge hose is connected to the connecting pipe I, with an impurity discharge end extending into the impurity collection chamber; the impurity collection filter bag is arranged inside the impurity collection chamber, and an opening of the impurity collection filter bag is sleeved on the impurity discharge end of the impurity discharge hose; and a filter bag access door is detachably mounted on one side of the bottom of the filtration box, and an air exhaust hole is disposed on the filter bag access door;
the high-pressure air introduction mechanism comprises a connecting pipe II, an air intake hose, an external connecting pipe, a control valve I, and a control valve II; the connecting pipe II is connected to the high-pressure air jet pipe, and the air intake hose is connected to the connecting pipe II; the external connecting pipe penetrates through a wall of the filtration box, with an air intake end connected to the air discharge connecting pipe, and an air exhaust end connected to an air intake end of the air intake hose; and the control valve I is arranged on the air discharge connecting pipe, an air intake end of the external connecting pipe is arranged between the induced draft fan and the control valve I, and the control valve II is arranged on the external connecting pipe;
the horizontal driving power mechanism comprises a fixing plate I, a fixing plate II, two guide strip plates, two horizontal movement screws, two synchronous wheels I, a synchronous belt I, a motor base, and a driving motor; the fixing plate I and the fixing plate II are fixedly mounted on the connecting pipe II and the connecting pipe I, respectively; the two guide strip plates slide through the fixing plate I and the fixing plate II, respectively, with two ends of each of the two guide strip plates fixedly connected to inner walls of two sides of the filtration chamber; the two horizontal movement screws are threaded through the fixing plate I and the fixing plate II in a driving manner, respectively, with two ends of each of the two horizontal movement screws rotatably connected to the inner walls of the two sides of the filtration chamber, two ends of each of the two horizontal movement screws extend outside the filtration box, and the guide strip plates and the horizontal movement screws are arranged in a same direction; the two synchronous wheels I are fixedly mounted at same ends of the two horizontal movement screws, respectively, and the synchronous belt I is looped around the two synchronous wheels I; and the motor base is fixedly mounted on one side of the filtration box, the driving motor is fixedly mounted on the motor base, and an output shaft of the driving motor is fixedly connected to an end of a corresponding horizontal movement screw;
an activated carbon layer is detachably mounted inside the filtration chamber, and the activated carbon layer is positioned above the air filtration net and the adsorption filtration net dredging mechanism; the catalytic purification box is internally divided into a photocatalytic purification chamber at an upper part and a spraying chamber at a lower part, the photocatalytic purification chamber is in communication with the air discharge connecting pipe, and the spraying chamber is in communication with the air discharge pipe; a plurality of rows of photocatalytic lamp tubes and catalytic reaction layers are mounted inside the photocatalytic purification chamber in a staggered manner, to catalyze and purify air; and the photocatalytic purification chamber and the spraying chamber are in communication via a guiding elbow pipe;
two cleaning plates are fixedly mounted at the top of the impurity collection pipe, the two cleaning plates are positioned on two sides of each of the plurality of impurity collection hoods, and the two cleaning plates are used for sweeping a lower surface of the air filtration net as the impurity collection pipe moves horizontally;
a plurality of electrostatic adsorption rods are arranged below the activated carbon layer, and the plurality of electrostatic adsorption rods are detachably mounted inside the filtration chamber; a debris removal mechanism is arranged inside the filtration chamber, and the debris removal mechanism comprises a dust-scraping sleeve plate slidably sleeved on the plurality of electrostatic adsorption rods; a synchronous plate is fixedly mounted at a bottom of the dust-scraping sleeve plate, and a bottom of the synchronous plate is fixedly connected to the fixing plate I; and a brush sweeper is mounted at a top of the dust-scraping sleeve plate, and the brush sweeper is in contact with a bottom of the activated carbon layer;
a power transmission shaft is rotatably mounted on the motor base, power transmission is achieved between the power transmission shaft and the horizontal movement screws achieve via bevel gears, and synchronous rotation is achieved between a camshaft and the power transmission shaft via the synchronous wheels II and a synchronous belt II; and
a flapping cam is fixedly mounted on a segment of the camshaft located inside the impurity collection chamber, and is used for flapping the impurity collection filter bag inflated by air flow.

2. The photocatalytic purification device according to claim 1, wherein the high-pressure air jet pipe, the impurity collection pipe, the connecting pipe I, and the connecting pipe II are all rigid pipes, and a frame edge width of the rectangular frame is greater than a width of the high-pressure air jet pipe, the impurity collection pipe, the connecting pipe I, the connecting pipe II, the fixing plate I, and the fixing plate II.

3. The photocatalytic purification device according to claim 1, wherein a diameter of the external connecting pipe is larger than that of the air intake hose, the air intake end of the external connecting pipe is inclined in a windward direction, and the windward direction refers to a direction from an air outlet end of the induced draft fan to an air exhaust end of the air discharge connecting pipe.

4. The photocatalytic purification device according to claim 1, wherein rectangular sliding openings and threaded holes are disposed on the fixing plate I and the fixing plate II, the guide strip plates slide through corresponding rectangular sliding openings, and the horizontal movement screws penetrate through corresponding threaded holes in a threaded engagement manner.

5. The photocatalytic purification device according to claim 1, which is applied to the treatment of wastewater and waste gas.

6. The photocatalytic purification device according to claim 2, which is applied to the treatment of wastewater and waste gas.

7. The photocatalytic purification device according to claim 3, which is applied to the treatment of wastewater and waste gas.

8. The photocatalytic purification device according to claim 4, which is applied to the treatment of wastewater and waste gas.
